(19) United States
(12) Patent Application Publication
(10) Pub. No.: US 2021/0089998 A1
(43) Pub. Date: Mar. 25, 2021

(54) SYSTEM AND METHOD FOR PROCESS MANAGEMENT

(71) Applicant: Jerryll Noorden, Bristol, CT (US)

(72) Inventor: Jerryll Noorden, Bristol, CT (US)

(21) Appl. No.: 17/031,630

(22) Filed: Sep. 24, 2020

Related U.S. Application Data
(60) Provisional application No. 62/905,148, filed on Sep. 24, 2019.

(51) Int. Cl. G06Q 10/06; G06F 16/9535; G06F 16/9538

(52) U.S. Cl. CPC G06Q 10/063114; G06Q 10/06316; G06F 16/9538; G06F 16/9535; G06Q 10/063112

(57) ABSTRACT

A method for improved process management of search engine optimization of a web site includes a set of processes including using an external device interface of a user terminal to display a set of tasks for completion by a user, using an administrator console to monitor the user's progress in completing the tasks, and to determine completion of the tasks. The administrator console may be used to evaluate the tasks as they are determined to be completed and to provide feedback as to whether the tasks have been completed successfully. Certain processes may be displayed on the user terminal only after other processes have been determined to be completed successfully.

### CROSS REFERENCE TO RELATED APPLICATION

This application claims the benefit of U.S. Provisional Application No. 62/905,148, filed 24 Sep. 2019, which is incorporated by reference herein in its entirety.

### FIELD

The disclosed exemplary embodiments are directed to a system and method for improved process management that provides interactive activity and task management.

### BACKGROUND

It would be advantageous to provide a platform that guides a user through a process that segregates a process for accomplishing a goal into a set of tasks and provides interactive guidance for accomplishing the tasks.

### SUMMARY

The disclosed embodiments are directed to a system and method for improved process management that segregates a process for accomplishing a goal into a set of tasks, optionally specifies an order for accomplishing each task, and tracks the completion of each task.

The system allows for continuous interaction between a user and a support person while completing a process comprising a set of tasks. While a user works independently on a task, a support person may monitor the user's activity and provide support when requested. The support may be in the form of the user interactively asking questions and receiving answers. The answers may be in the form of an in person visit, a text, audio, or video presentation, a 3D or holographic display, any type of interactive text, audio or video chat with the support person, or any other type of presentation medium. This provides the user with constant interactive guidance upon request.

The system may automatically segregate the process into a sets of activities and tasks based on the type of process.

Based on the type of process, the system may specify an order for all the activities and tasks, some of the activities and tasks, or may allow activities and tasks to be accomplished in any order.

Certain future tasks may become visible only after some particular tasks have been accomplished and interactively approved by a support person. When a particular set of tasks has been completed, a support person will evaluate the completed tasks and provide feedback as to whether the tasks have been completed successfully. If the tasks have been completed successfully, additional tasks of the process become visible. This forces a user to concentrate on and finish one or more particular tasks without distraction before moving on to further tasks.

The system may also provide guidance for accomplishing each task upon a user selecting the task, and may optionally provide a review process for each task in order to move on to the next task. The guidance for each activity and task may be provided in any type of presentation format, for example, any combination of a visual, audio, or audio-visual format. For example, the visual guidance may include a text document with directions for accomplishing the task, an animated video showing how the task may be completed, or a live action video with sound demonstrating how to accomplish the task. In addition, the guidance may be provided in an automated interactive manner using a guided set of steps to perform, or in an interactive one-on-one manner, for example, in person, using a form of audio communication, text communication, for example using a dialog box, or using a form of audio visual communication.

The review process may also be provided in an automated interactive manner using a guided set of steps to perform, or in an interactive one-on-one manner, for example, in person, using a form of audio communication, text communication, for example using a dialog box, or using a form of audio visual communication.

The system further provides a user interface that facilitates the continuous interaction between the user and support person and provides status indicators for the tasks to the user.

Examples of processes that may utilize the disclosed system may include a search engine optimization process and a real estate wholesaling process.

The disclosed embodiments are directed to a method for improved process management of search engine optimization of a web site including a set of processes including using an external device interface of a user terminal to display a set of initial web site preparation tasks for completion by a user, using an administrator console to monitor the user's progress in completing the initial web site preparation tasks, and to determine completion of the initial web site preparation tasks, using the external device interface to display a set of branding and social media promotion tasks for completion by the user, using the administrator console to monitor the user's progress in completing the branding and social media promotion tasks, and to determine completion of the branding and social media promotion tasks, using the external device interface to display a set of web site set up tasks for completion by the user, using the administrator console to monitor the user's progress in completing the web site set up tasks, and to determine completion of the web site set up tasks, using the external device interface to display a set of content strategies for completion by the user, using the administrator console to monitor the user's progress in completing the content strategies, and to determine completion of the content strategies, using the external device interface to display a set of on page search engine optimization strategies for completion by the user, using the administrator console to monitor the user's progress in completing the on page search engine optimization strategies, and to determine completion of the on page search engine optimization strategies, using the external device interface to display a set of conversion and credibility strategies for completion by the user, using the administrator console to monitor the user's progress in completing the conversion and credibility strategies, and to determine completion of the conversion and credibility strategies, using the external device interface to display a set of tasks for establishing the web site as an authoritative source of information for completion by the user, using the administrator console to monitor the user's progress in completing the set of tasks for establishing the web site as an authoritative source of information, and to determine completion of the set of tasks for establishing the web site as an authoritative source of information, using the external device interface to display a set of tasks for backlink building for completion by the user, using the administrator console to monitor the user's progress in completing the set of tasks for backlink building, and to determine completion of the set of tasks for backlink building, using the external device interface to display a set of tasks for research and development for completion by the user, using the administrator console to monitor the user's progress in completing the set of tasks for research and development, and to determine completion of the set of tasks for research and development, using the external device interface to display a set of tasks for implementing advanced search engine optimization strategies for completion by the user, using the administrator console to monitor the user's progress in completing the set of tasks for implementing advanced search engine optimization strategies, and to determine completion of the set of tasks for implementing advanced search engine optimization strategies, using the external device interface to display a set of tasks for implementing group search engine optimization strategies for completion by the user, using the administrator console to monitor the user's progress in completing the set of tasks for implementing group search engine optimization strategies, and to determine completion of the set of tasks for implementing group search engine optimization strategies, and using the external device interface to display a set of marketing tasks for completion by the user, using the administrator console to monitor the user's progress in completing the set of marketing tasks, and to determine completion of the set of marketing tasks.

The disclosed embodiments are further directed to a system for improved process management of processes for search engine optimization of a web site, the system including an external device interface of a user terminal configured to display a set of initial web site preparation tasks for completion by a user, an administrator console configured to monitor the user's progress in completing the initial web site preparation tasks, and for allowing an administrator to determine completion of the initial web site preparation tasks, the external device interface further configured to display a set of branding and social media promotion tasks for completion by the user, wherein the administrator console is further configured to monitor the user's progress in completing the branding and social media promotion tasks, and for allowing the administrator to determine completion of the branding and social media promotion tasks, the external device interface further configured to display a set of web site set up tasks for completion by the user, wherein the administrator console is further configured to monitor the user's progress in completing the web site set up tasks, and for allowing the administrator to determine completion of the web site set up tasks, the external device interface further configured to display a set of content strategies for completion by the user, wherein the administrator console is further configured to monitor the user's progress in completing the content strategies, and for allowing the administrator to determine completion of the content strategies, the external device interface further configured to display a set of on page search engine optimization strategies for completion by the user, wherein the administrator console is further configured to monitor the user's progress in completing the on page search engine optimization strategies, and for allowing the administrator to determine completion of the on page search engine optimization strategies, the external device interface further configured to display a set of conversion and credibility strategies for completion by the user, wherein the administrator console is further configured to monitor the user's progress in completing the conversion and credibility strategies, and for allowing the administrator to determine completion of the conversion and credibility strategies, the external device interface further configured to display a set of tasks for establishing the web site as an authoritative source of information for completion by the user, wherein the administrator console is further configured to monitor the user's progress in completing the set of tasks for establishing the web site as an authoritative source of information, and for allowing the administrator to determine completion of the set of tasks for establishing the web site as an authoritative source of information, the external device interface further configured to display a set of tasks for backlink building for completion by the user, wherein the administrator console is further configured to monitor the user's progress in completing the set of tasks for backlink building, and for allowing the administrator to determine completion of the set of tasks for backlink building, the external device interface further configured to display a set of tasks for research and development for completion by the user, wherein the administrator console is further configured to monitor the user's progress in completing the set of tasks for research and development, and for allowing the administrator to determine completion of the set of tasks for research and development, the external device interface further configured to display a set of tasks for implementing advanced search engine optimization strategies for completion by the user, wherein the administrator console is further configured to monitor the user's progress in completing the set of tasks for implementing advanced search engine optimization strategies, and for allowing the administrator to determine completion of the set of tasks for implementing advanced search engine optimization strategies, the external device interface further configured to display a set of tasks for implementing group search engine optimization strategies for completion by the user, wherein the administrator console is further configured to monitor the user's progress in completing the set of tasks for implementing group search engine optimization strategies, and for allowing the administrator to determine of the set of tasks for implementing group search engine optimization strategies, and the external device interface further configured to display a set of marketing tasks for completion by the user, wherein the administrator console is further configured to monitor the user's progress in completing the set of marketing tasks, and for allowing the administrator to determine completion of the set of marketing tasks.

### BRIEF DESCRIPTION OF THE DRAWINGS

FIG. 1 shows a schematic illustration of a system according to the disclosed embodiments;

FIG. 2 shows a simple block diagram of a process that has been divided into a series of activities and tasks required to complete the process;

FIGS. 3-7 illustrate an interface and a process for managing the activities and tasks;

FIG. 8 shows a block diagram of groups of activities for implementing search engine optimization strategies according to the disclosed embodiments;

FIGS. 9-20 illustrate the tasks for implementing the activities shown in FIG. 8.

FIG. 21 shows a block diagram of groups of activities for implementing a real estate wholesaling process according to the disclosed embodiments; and

FIGS. 21-25 illustrate the tasks for implementing the activities shown in FIG. 21.

### DETAILED DESCRIPTION

The aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention.

The disclosed embodiments are directed to an interactive process management system that includes segregating the process into a number of tasks, optionally specifying an order for accomplishing each task, providing guidance for accomplishing each task, and providing a review process for each task in order to complete the process.

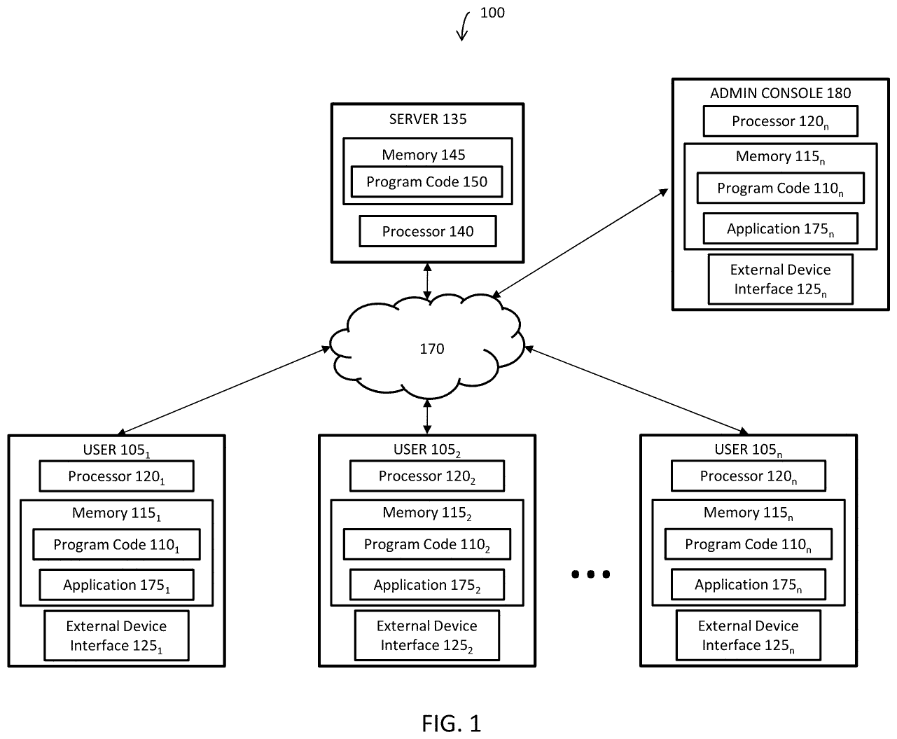

FIG. 1 shows a schematic illustration of an exemplary platform 100 on which the disclosed process management system may be implemented, according to the disclosed embodiments. The system 100 may include one or more user terminals 105₁-105ₙ, an administrator console 180, and at least one server 135. The user terminals 105₁-105ₙ and administrator console 180 may operate an application 175₁-175ₙ that provides access to the server 135, for example, through an external device interface 125₁-125ₙ that may include a web browser. The user terminals 105₁-105ₙ and administrator console 180 may provide access at anytime from anywhere and may include for example, desktop computers, laptops, tablets, mobile phones, or any other computing devices capable of performing the functions of the disclosed embodiments. It should be understood that a user may utilize more than one and different types of the user terminals 105₁-105ₙ to access the server 135. For example, a user may use a mobile phone as a user terminal at one point in time to access the system and later may use a tablet as a user terminal. It should also be understood that an administrator may utilize more than one and different types of the administrator console 180 to access the server 135. For example, an administrator may use a mobile phone as an administrator console at one point in time to access the system and later may use a tablet as an administrator console.

Each user terminal 105₁-105ₙ and the administrator console 180 may include computer readable program code 110₁-110ₙ stored on at least one non-transitory computer readable medium for carrying out and executing the processes described herein. In at least one embodiment, the computer readable program code 110₁-110ₙ may invoke or operate the application 175₁-175ₙ for accessing the server 135. The computer readable medium may include memories 115₁-115ₙ, and in alternate aspects, the computer readable program code 110₁-110ₙ may be stored in memories external to, or remote from, user terminals 105₁-105ₙ. Memories 115₁-115ₙ may include magnetic media, semiconductor media, optical media, or any media which is readable and executable by a computer. Each user terminal 105₁-105ₙ and the administrator console 180 may also include a processor 120₁-120ₙ for executing the computer readable program code 110₁-110ₙ.

The at least one server 135 may include a processor 140, and memory 145 storing computer program code 150 for generally operating the server 135 to provide the search engine optimization platform described herein. In some embodiments, the at least one server 135 may be implemented by a cloud computing service, and the search engine optimization system may be provided in the form of software as a service (SaaS). The various components of the platform 100, including the user terminals 105₁-105ₙ, the administrator console 180, and that at least one server 135, may communicate over a network 170.

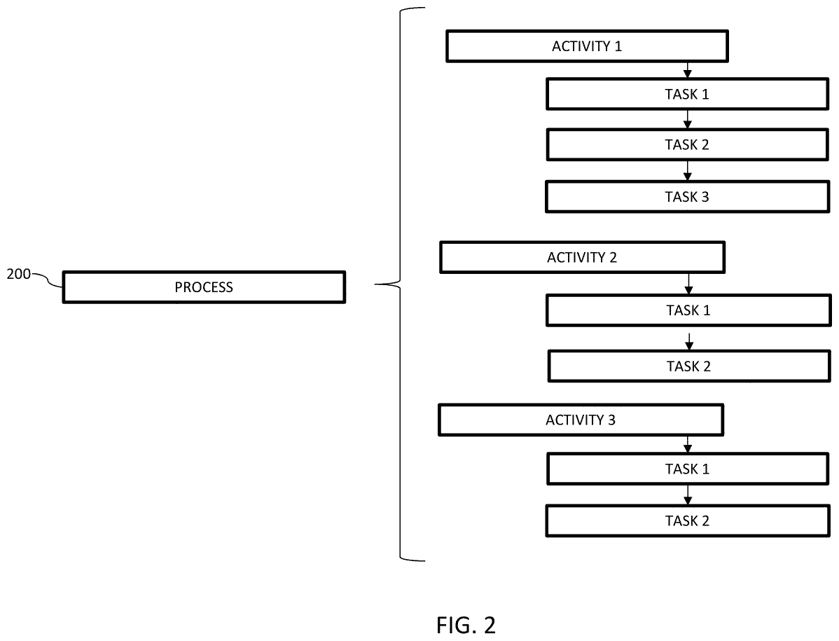

FIG. 2 shows a simple block diagram of a process 200 that has been divided into a series of activities and tasks required to complete the process. While the process is shown as a series of activities and tasks, it should be understood that the process may include only activities, only tasks, or a combination of activities and tasks. In some embodiments, the system may recognize the specified process and provide a pre-determined set of tasks for completing the process. In the examples described below, the system may have a comprehensive predefined set of activities and tasks, for example, for optimizing search engine rankings for a web site or, as another example, for wholesaling real estate. Upon selection of, or the specification of, a process for which the system has predetermined activities and tasks, the system may automatically generate the associated activities and tasks.

In some embodiments, the type of process, whether the process is recognized by the system or not, may require that all activities and tasks be accomplished in a specified order, may require that only some of the activities and tasks be accomplished in a specified order, or may allow the activities and tasks to be accomplished in any order. In some embodiments, the activities and tasks may be stored in the memory 145 of the server 135.

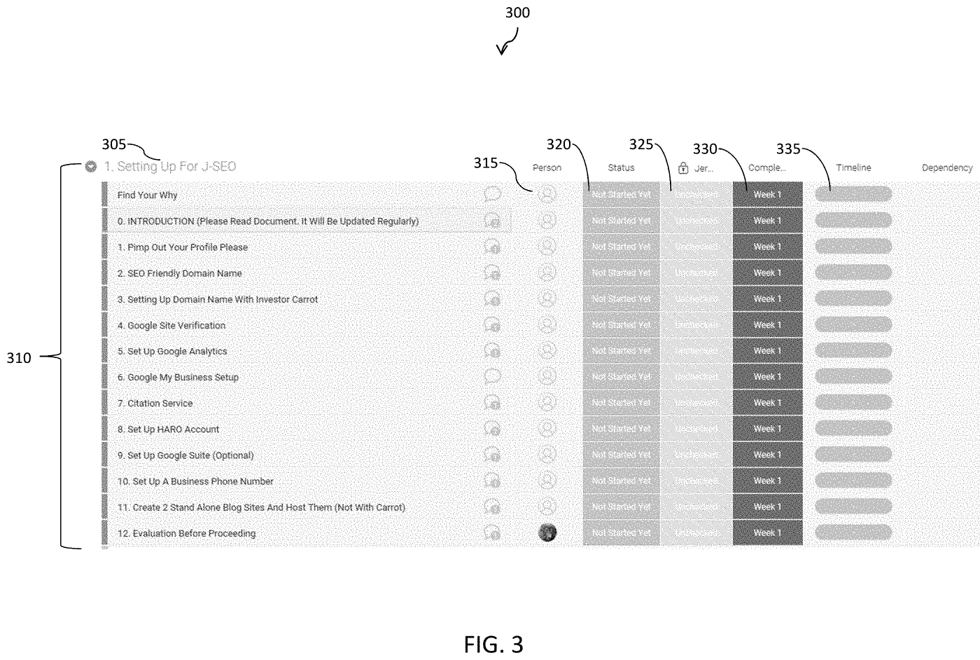

The activities and tasks may be managed and presented to a user in a guided fashion using an interface 300 which may be displayed on an external device interface 125 of a user terminal 105, an example of which is shown in FIG. 3. The interface 300 may be generated upon specifying a process to be accomplished. In some embodiments, the activities and tasks shown in the interface 300 may be input by a user. In other embodiments, the specified process may be recognized by the system, and the system may automatically generate a set of activities and tasks for completing the specified process. In the event that the system automatically generates a set of activities and tasks for completing the specified process, for some example processes, a user may be provided with the opportunity to add, delete, or modify one or more of the activities or tasks.

The interface 300 may include a listing of an activity 305, the individual tasks 310 required to accomplish or complete the activity 305, an indication of a responsible person 315, a status indicator 320, an approval indicator 325, a projected completion date 330, and a proposed timeline 335.

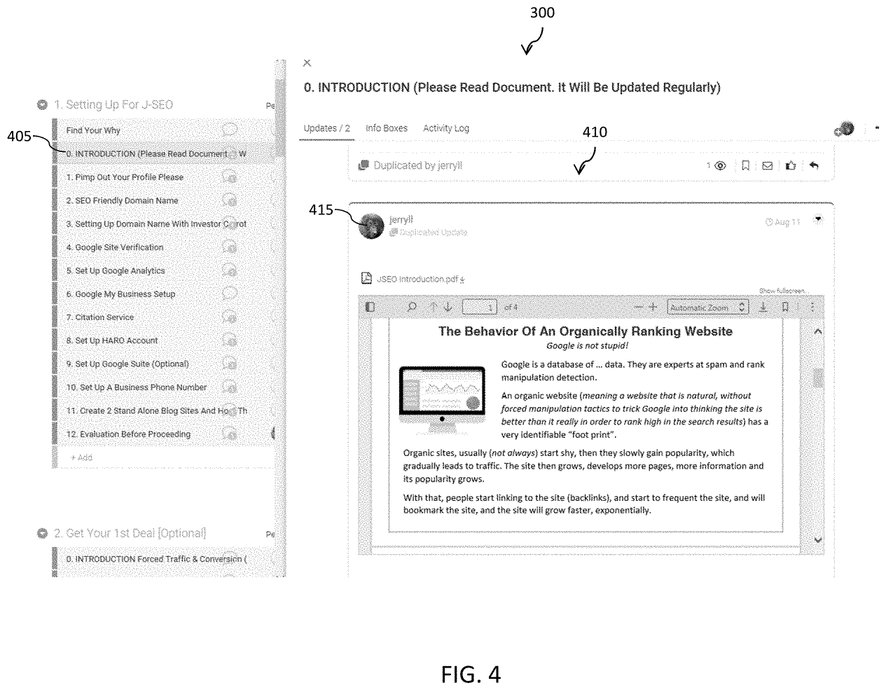

As shown in FIG. 4, selecting a particular task 405 may cause guidance 410 for accomplishing the task to be displayed. The guidance 410 may generally include an explanation of the task, background information associated with the task, and instructions for completing the task. The explanation may optionally include instructions as to an order for completing the task. The guidance 410 may be displayed within the interface 300, for example, as a pop up, or may displayed outside or adjacent the interface 300. The guidance 410 may be in the form of any combination of a visual, audio, or audio-visual format. For example, if provided visually, the guidance 410 may include a text document with directions for accomplishing the task, an animated video showing how the task may be completed, or a live action video with sound demonstrating how to accomplish the task. In addition, the guidance 410 may be provided in an automated interactive manner using a guided set of steps to perform, or in an interactive one-on-one manner, for example, in person, using a form of audio communication, text communication, for example using a dialog box, or using a form of audio visual communication. The guidance 410 may optionally include an identification of, or a link to, an administrator 415 that may be contacted for additional guidance.

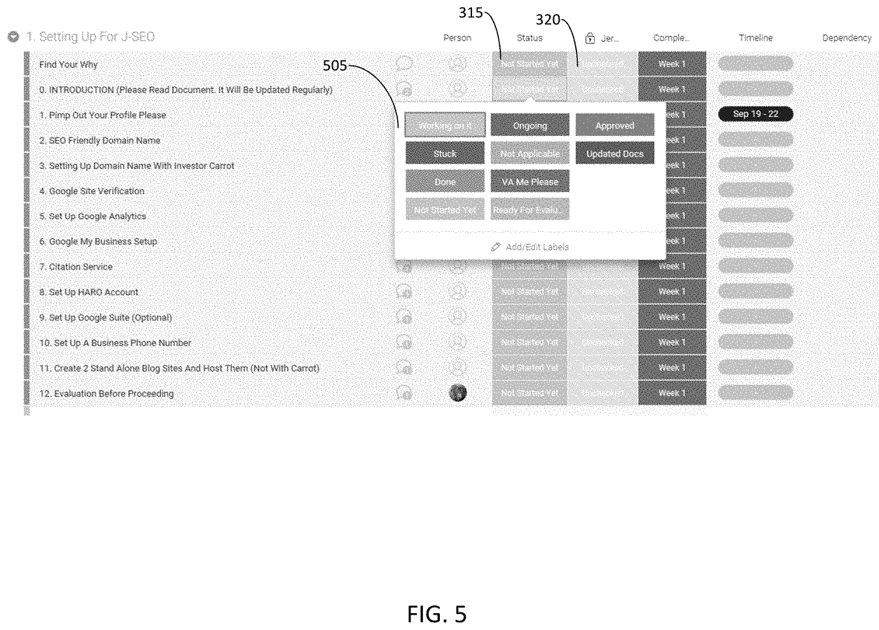

As shown in FIG. 5, selecting a status indicator 315 for a particular task provides a menu of possible selections 505. According to the disclosed embodiments, selection of at least one menu selection, for example, “Stuck” or “VA Me Please,” may include requesting assistance which may initiate a guided troubleshooting procedure or may initiate a live interactive exchange for providing a solution. Similar to the guidance described above, the assistance may be provided in an automated interactive manner using a guided set of steps to perform, or in an interactive one-on-one manner, for example, in person, using a form of audio communication, text communication, for example using a dialog box, or using a form of audio visual communication.

Selection of at least one other menu selection, for example, “Ready for Evaluation” may initiate a review process by an administrator to ensure that when the results of the task are implemented, they are effective and do not cause any negative effects. The review process may also include advice on how to improve the results of the task. The review process may be provided in an automated interactive manner using a guided set of steps to perform, or in an interactive one-on-one manner, for example, in person, using a form of audio communication, text communication, for example using a dialog box, or using a form of audio visual communication. Upon receiving results of the review process, a user may optionally incorporate the results and the review process may optionally be repeated until completed. Upon completion of the review process, the approval indicator 320 may change in appearance to indicate that the task has been successfully completed. It should be understood that some tasks may not require review and may simply be completed. An example menu selection for such a task may be the “Done” indicator.

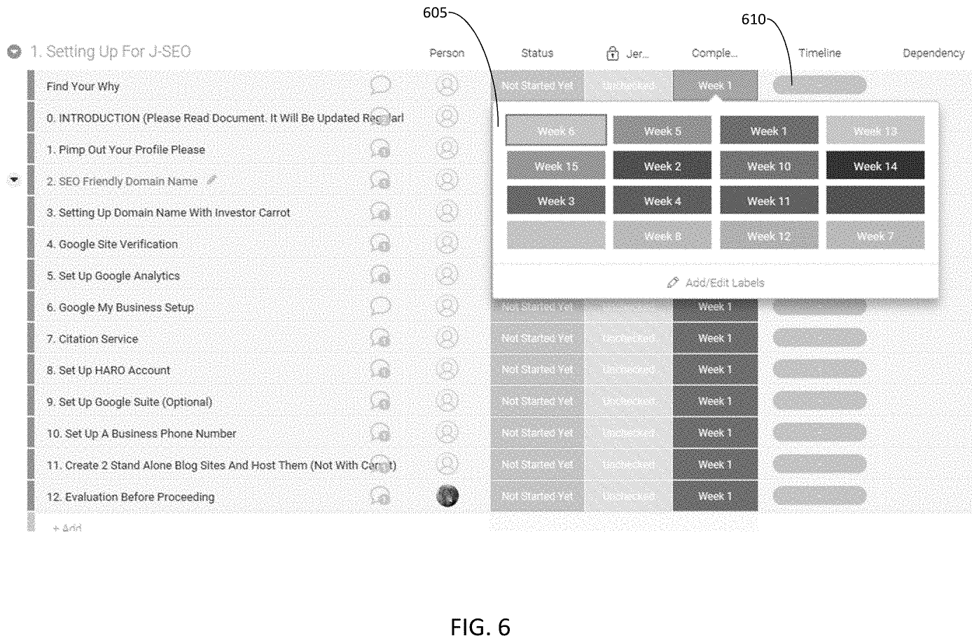

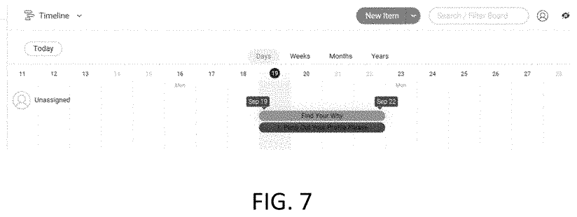

As shown in FIG. 6, selecting a projected completion date provides a menu 605 of possible weeks to select, and selecting the proposed timeline indicator 610 allows for selection of a timeline for the task as shown in FIG. 7.

It should be understood that the disclosed system and method for improved process management may be used for accomplishing any suitable process, including various processes that may be quire diverse. For example, the disclosed system and method may be used for search engine optimization of web sites. As another example, the disclosed system and method may be used for a real estate wholesaling process. While the following examples include activities and tasks described in a specific order, it should be understood that the activities and tasks may be accomplished in any order suitable for achieving the search engine optimization. In addition, while various activities and tasks are described for improved process management of specific processes, it should be understood that some activities and tasks may be optional and need not executed in order to perform the overall process.

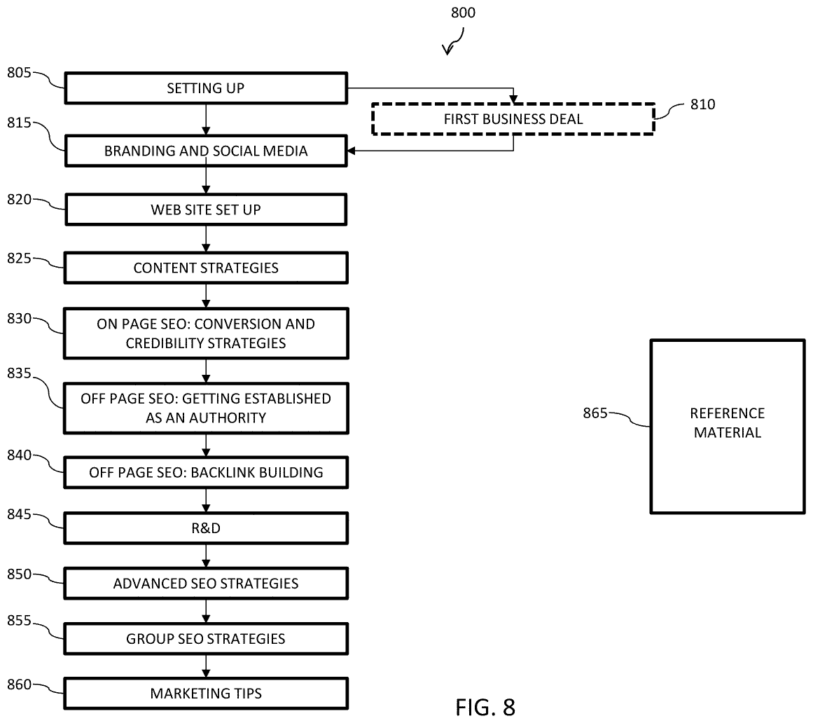

FIG. 8 shows a block diagram 800 of groups of activities for implementing search engine optimization strategies according to the disclosed embodiments.

Presently available search engine optimization tools are limited in that they typically address a limited number of characteristics of a web site but do not offer a comprehensive system for organically achieving consistently higher search engine ratings.

A website that includes forced manipulation tactics for achieving high rankings in search results generally has readily identifiable characteristics that are recognized by search engines and may actually result in lower rankings. At the same time, a website that naturally grows, develops more pages and more traffic, and achieves backlinks without solicitation or manipulation, also has readily identifiable characteristics. It would be advantageous to provide a platform that guides a user through a process that consistently achieves high rankings through an organic process of constant improvement of a web site.

A set of activities 800 for implementing a search optimization method may include setting up 805, obtaining a business deal 810, which may be optional, branding and social media 815, web site set up 820, content strategies 825, on page SEO: conversion and credibility strategies 830, off page SEO: getting established as an authority 835, off page SEO: backlink building 840, R&D 845, advanced SEO strategies 850, group SEO strategies 855, and marketing tips 860. The activities may be supplemented by reference material 865. Each of the activities will now be explained in detail.

### Setting Up 805

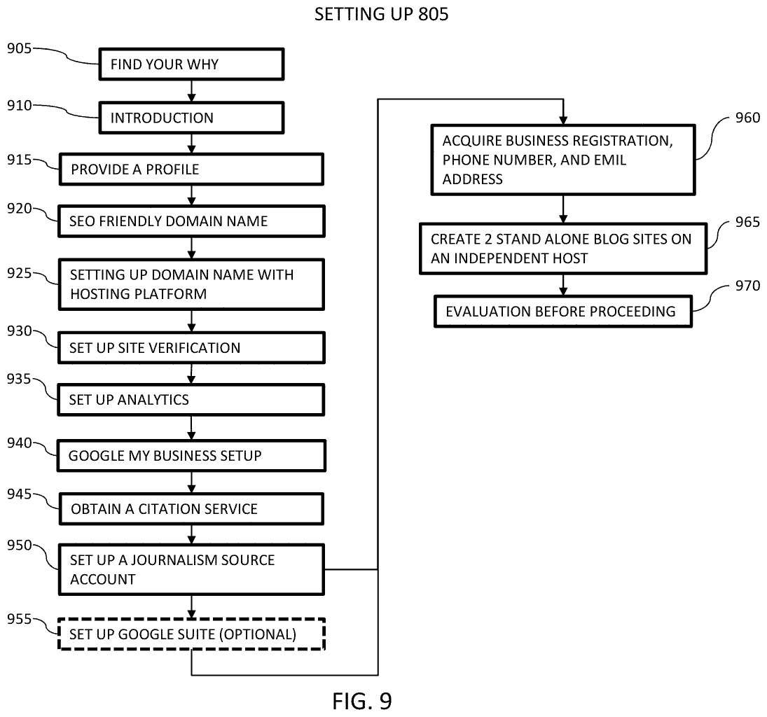

As shown in FIG. 9, the setting up activity 805 may include the following tasks: Find Your Why 905, Introduction 910, Pimp Out Your Profile Please 915, SEO Friendly Domain Name 920, Setting Up Domain Name With Hosting Platform 925, Google Site Verification 930, Set Up Google Analytics 935, Google My Business Setup 940, Citation Service 945, Set Up a Journalism Source Account 950, Set Up Google Suite (Optional) 955, Set Up A Business Phone Number 960, Create 2 Stand Alone Blog Sites And Host Them (Not With Carrot) 965, Evaluation Before Proceeding 970.

The Introduction 910 may generally explain the philosophy of the platform operations, introduce the operation of the platform, explain the disadvantages of previous methods, and explain the operation of the interface.

The Provide a Profile task 915 generally advises providing profile information and a picture and assigning the activities and tasks to the user.

The SEO Friendly Domain Name task 920 provides advice on choosing a descriptive domain name and suggests requesting assistance if required.

The Setting Up Domain Name With Hosting Platform task 925 includes step by step actions for attaching the selected domain name to a web site on a hosting platform. An exemplary hosting platform may be “Investor Carrot.” The task involves managing the domain name settings, adding a non-www redirect, selecting the type of hosting plan, for example, choosing a plan that includes at least 2 automatically populated blog sites, choosing a site template, and testing the web site.

The Site Verification task 930 includes step by step actions for proving ownership of the web site to at least one search engine, for example, Google. To prove to the search engine that the user is the owner of your website requires verification. Once verified, the search engine will typically grant backstage data about the website, for example, Google Analytics, including traffic data. Based on that data, the user may adapt, change, and modify the web site to increase the search engine ranking. The actions may include setting up a tools account with the search engine provider, creating a property in the tools account, and verifying domain ownership via a DNS record.

The Set Up Analytics task 935 includes steps for obtaining a tracking ID, a default view that will gather data, a reporting view, creating filters for the data. The Analytics service will generate code to be inserted in the web site. The Set Up Analytics task 935 also includes steps for inserting the code as a tracking script for the website.

The Google My Business Setup task 940 includes setting up a business email system with the business domain as opposed to a service provider domain, for example, using myname@business.com, as opposed to mark@gmail.com, or mark@hotmail.com.

The Obtain a Citation Service task 945 includes setting up an account with a citation service. A citation is a “mention” of your business online, similar to a backlink, but without the actual link. Citations give search engines an indication that the web site represents a reputable business, and thus causes search engines to provide a higher ranking that sites without citations. There are several commercially available citation services with different features and different rates.

The Set Up A Journalism Source Account task 950 includes steps for setting up a Journalist Source Account. A Journalism Source Service is an online service for journalists to obtain information about various subjects from the public. It enables journalists to connect with experts in issues relevant to their reporting. Once subscribed to their mailing system (choose the free version) the user will receive daily emails with requests to submit/answer pitches journalists and reporters need answered. If a pitch is selected the user will receive at least a mention, and usually a backlink from their website. Set up generally includes signing up for an account, providing information about your area of expertise, and specifying which types of solicitations to receive.

The Set Up Google Suite task (Optional) 955 provides the ability to obtain a general business email, and emails for associates with the business extension.

The Acquire a Business Registration, Phone Number, and Email Address task 960 advises obtaining a general business registration and phone number and individual phone numbers for associates. Setting up the general business email and phone number, and emails and phone numbers for the associates, helps enhance the company and web site and builds customer trust.

The Create 2 Stand Alone Blog Sites on an Independent Host task 965 may include using a blog set up platform and different strategies for users that have already purchased a domain name, or that have not yet purchased a domain name.

For users that have a domain name, the task includes selecting a blog hosting service, for example, SiteGround Hosting, selecting a web hosting platform, for example, Wordpress, selecting a plan, registering the domain name, and providing payment information. The task further includes navigating to a control panel, adding the domain name, pointing DNS values to the web site's domain name, installing the web hosting platform, for example, Wordpress, encrypting the web site, and setting up a theme or template for the blog.

For users that do not yet have a domain name, the task includes selecting a blog hosting service, for example, SiteGround Hosting, selecting a web hosting platform, for example, Wordpress, selecting a plan, registering the domain name, and providing payment information. The task further includes installing the web hosting platform, for example, Wordpress, navigating to a control panel, encrypting the web site, and setting up a theme or template for the blog.

The Create 2 Stand Alone Blog Sites on an Independent Host task 965 may also include guidance for picking a domain names, and for selecting blog subjects.

The Evaluate Before Proceeding task 970 may generally include an evaluation of the results of the Setting Up activity using various techniques, for example, in an automated interactive manner using a guided set of steps to perform, or in an interactive one-on-one manner, for example, in person, using a form of audio communication, text communication, for example using a dialog box, or using a form of audio visual communication.

### Obtaining a Business Deal 810 (Optional)

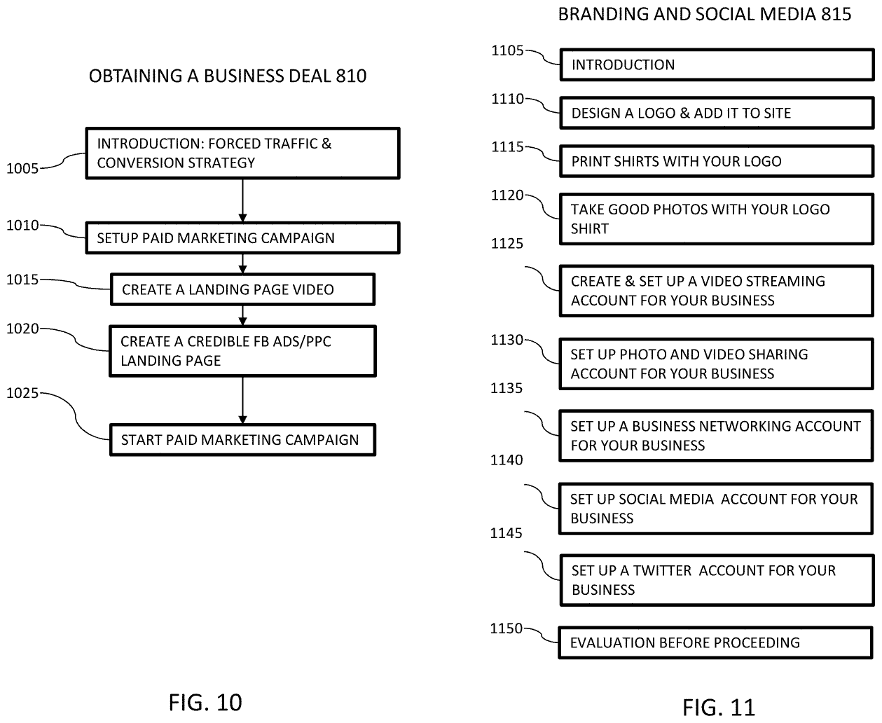

As shown in FIG. 10, the optional obtaining a business deal activity 810 may include the following tasks: Forced Traffic & Conversion Strategy 905, Setup Paid Marketing Campaign 910, Create A Landing Page Video 915, Create A Credible FB Ads/PCC Landing Page 920, and Start Paid Marketing Campaign 925.

The Forced Traffic & Conversion Strategy task 1005 may be an effective technique for increasing traffic and conversion.

The Setup Paid Marketing Campaign task 1010 includes shopping for a paid marketing vendor and establishing a relationship with one.

The Create A Landing Page Video task 1015 includes creating a video based on the same topic of the advertisement clicked on to arrive at page on which the video is located. For example, if the advertisement dealt with stopping foreclosure, the video should address stopping foreclosure as opposed to a more generic “Do you need to sell your house fast . . . .”

The Create A Credible Facebook Ads/Pay Per Click Landing Page task 1020 may include using pre-developed landing pages provided as part of the search engine optimization service.

Once the various tasks have been completed, the Start Paid Marketing Campaign task may proceed.

### Branding and Social Media 815

As shown in FIG. 11, the branding and social media activity 815 may include the following tasks: Introduction 1105, Design A Logo & Add It To Site 1110, Print Shirts With Your Logo 1115, Take good photos with your logo shirt 1120, Create & Set Up A Video Streaming, for example, YouTube, Account For Your Business 1125, Set Up A Photo and Video Sharing, for example, Instagram, Account For Your Business 1130, Set Up A Business Networking, for example, LinkedIn, Account For Your Business 1135, Set Up A Social Media, for example, Facebook, Account For Your Business 1140, Set Up A Twitter Account For Your Business 1145, and Evaluation Before Proceeding 1150

The Introduction task 1105 may include submitting the user's social media profiles for evaluation.

The Design A Logo & Add It To Site task 1110 includes designing an effective logo. While it may be hard to give instructions on how to design a logo, the logo may be anything as long as it identifies the associated business. The logo should ideally be simple, for example, Nike. A logo should be printable, and embroidable, without adding too much complexity in the process. In general a logo may ideally have no more than 3 colors. A logo may also have an element in it that pops and is memorable.

The Print Shirts With Your Logo task 1115 may include providing shirts from a vendor selected by the search optimization service.

Take High Quality Photos with the Logo Shirt task 1120 represents a significant credibility metric. Ideal pictures would include the user with a nice yet confident smile, friendly confident approachable, in great lighting, on the home page, the about us page and the company page, if present. Quality pictures are important, sub quality pictures may require significant work on other credibility metrics.

The Create & Set Up A YouTube Account For Your Business task 1125 is another significant task and not just a simple creation of a YouTube channel. This account represents a call to action setting the stage for a powerful SEO strategy available in the SEO+Credibility Package. The end product will be a powerful hub for videos. The task includes a step by step process for creating a You Tube Channel, including creating a Google account, setting up a personal channel for added credibility, and customizing the personal channel. The customizing may include adding a picture, for example, using Photoshop or a commercial picture service. Some picture services may include automatic or custom size selection based on the target platform. The task may further include a step by step process for attaching a brand channel to the personal channel and customizing the business brand channel. The customizing may include adding a company logo to the brand channel and adding and customizing the brand channel art.

The Set Up Instagram Account For Your Business 1130, Set Up Linked In Account For Your Business 1135, Set Up Facebook Account For Your Business 1140, and Set Up A Twitter Account For Your Business 1145 tasks all include step by step procedures for setting up these accounts.

The Evaluate Before Proceeding task 1150 may generally include an evaluation of the results of the activity using various techniques, for example, in an automated interactive manner using a guided set of steps to perform, or in an interactive one-on-one manner, for example, in person, using a form of audio communication, text communication, for example using a dialog box, or using a form of audio visual communication.

### Web Site Set Up 820

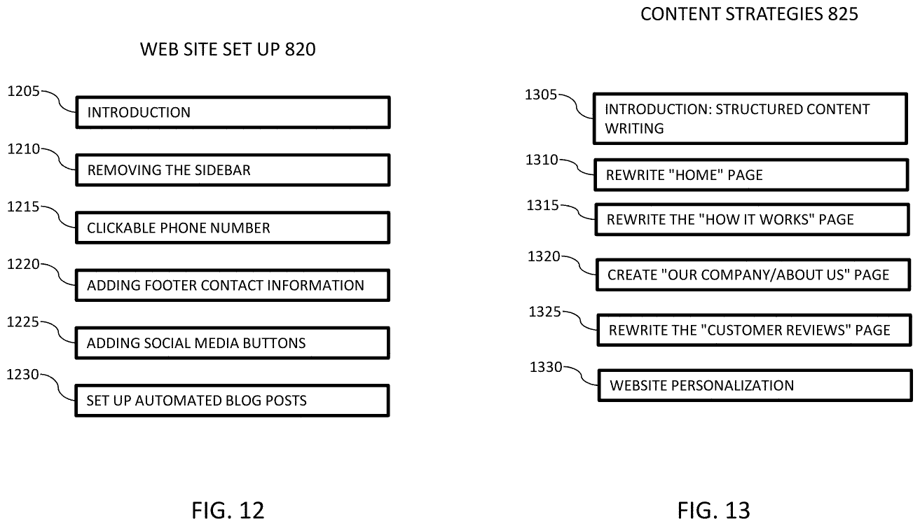

As shown in FIG. 12, the web set up activity 820 may include the following tasks: Introduction 1205, Removing The Sidebar 1210, Clickable Phone Number 1215, Adding Footer Contact Information 1220, Adding Social Media Buttons 1225, Set Up Automated IC Blog Posts 1230.

The Introduction task 1205 provides an introduction to setting up a web site and introduces a set of options that result in better site performance.

The Removing The Sidebar task 1210 recommends removing the sidebar because the main content will generally be competing with the side bar content. Having 2 separate pieces of information on one horizontal line tends to make the website chaotic, cluttered, and intimidating to read. The task provides step by step directions for removing the sidebar.

The Clickable Phone Number task 1215 provides step by step directions for adding a clickable phone number with color to the web site.

The Adding Footer Contact Information task 1220 provides step by step instructions, along with generic code for adding contact information and a logo to the web site footer.

The Adding Social Media Buttons task 1225 provides step by step instructions, along with generic code for adding social media icons to the web site. This task provides recommendations for ideal placement for maintaining contact with the web site as opposed to sending traffic away.

The Set Up Automated Blog Posts tasks 1230 provides step by step instructions for implementing a powerful SEO strategy that makes use of automated blog posts using a service provided by the hosting platform, for example Investor Carrot. After logging in, the user is provided with various types of available blog posts. After selecting the type of blog post, the user may select one or more blog topics, and may further select packages of blog posts available for publishing on the web site. Upon selection of a particular package, the user may direct the contents of the package to a particular blog site and select a frequency at which the blogs in the package may be presented.

### Content Strategies 825

As shown in FIG. 13, the content strategies activity 825 generally includes using a structured content writing procedure to generate content for the website. The structured content writing procedure may include the following tasks: Introduction: Structured Content Writing 1305, Rewrite “Home” Page 1310, Rewrite The “How It Works” Page 1315, Create “Our Company/About Us” Page 1320, Rewrite The “Customer Reviews” Page 1325, and Website Personalization 1330.

The Introduction: Structured Content Writing task 1305 provides a set of step by step instructions for functional search engine optimization. The previous activities have been directed to setting up a solid foundation for search engine optimization and the structure and content of the web site will now be modified to take advantage of the foundational work. The suggested order of accomplishing this is optional.

The Structured Content Writing task 1305 includes the following steps: 1. Define Overall Purpose Of The Page; 2. Break down how you want to accomplish this goal (Content Blocks); 3. Define the goal/purpose for each block; and 4. Write content for each block that satisfies the goal of that block. Each webpage on the site should have a purpose that should be determined before writing any content. Once the purpose is determined, a page structure should be created that satisfies that purpose. This ensures that the web pages have a solid structure and layout that flows seemingly from one section to the next.

The Rewrite “Home” Page task 1310, Rewrite The “How It Works” Page task 1315, Create “Our Company/About Us” Page task 1320, and Rewrite The “Customer Reviews” Page task 1325 may all be accomplished by following these guidelines.

The Website Personalization task 1330 generally provides recommendations for personalizing the web site in a manner that increases traffic and search engine ratings. The task may generally include choosing colors and using a consistent theme across the web site, avoiding too many colors or random web art (like checkmarks) on the site as it makes the site cluttered and chaotic, and that the content, in particular, checkmarks, numbering, and banner art be original, in order to provide a custom, legitimate look that will bring trust, traffic, and ultimately conversion. The task may include adding bright and colorful visuals that are functional as opposed to being added simply for the sake of having visuals. The task may further include judicial addition of pictures, keeping in mind that pictures require time to load and will slow the site's load speed, a search engine ranking factor. The faster the site loads, the better user experience (UX), and the more the various search engines will provide higher ratings. At the same time, adding pictures (and media in general) adds to the SEO score, so adding a picture that is functional to conversion (and to rankings) may be beneficial. While video does not typically result in many clicks, video still gives a powerful credibility signal. Simply knowing that there is a video of an actual person talking about what they do and who they are, especially if the video as a thumbnail with the owner showing ideally with a shirt with the logo of the company will give a user the confidence that the website is legitimate.

### On Page SEO: Conversion and Credibility Strategies 830

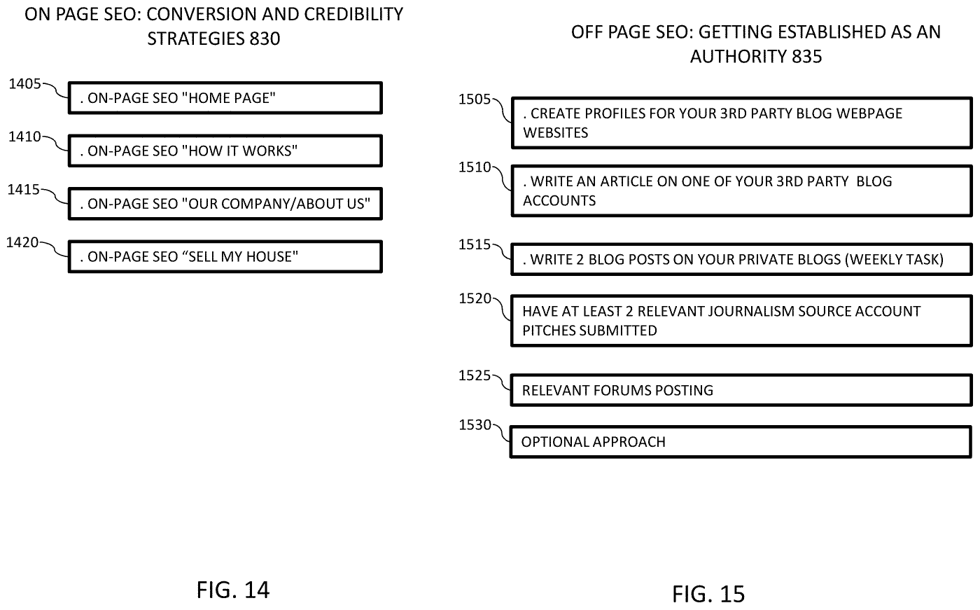

As shown in FIG. 14, the on page SEO: conversion and credibility strategies activity 830 may include the following tasks: On-Page SEO “Home Page” 1405, On-Page SEO “How It Works” 1410, On-Page SEO “Our Company/About Us” 1415, and On-Page SEO “Sell My House” 1420.

The On Page SEO: Conversion and Credibility Strategies includes a comprehensive guide on how to approach on-page SEO. The concepts set out in the On-Page SEO “Home Page” task 1405 are equally applicable to other sections of the web site, for example, “How It Works,” and “Our Company/About Us” pages. Starting with a set of pages of raw content, each section of a page is addressed to make content writing as efficient as possible. It should be understood that this is an iterative process and that additional editing will occur later after traffic begins to increase.

By transforming “Block Titles” into headers, using the blocks will result in having a header structure set up automatically for publishing subsequent articles. The task may begin by making a list of keywords for ranking. Rather than using the traditional way of finding keywords using, for example, Google's keyword volume checker, a better way to find keywords is to visit forums, and interview traffic during calls to discover what search terms were used to arrive at the web site. It should be noted that the main keyword should ideally be used well within the first 100 words of content, in particular to immediately inform visitors of the web site content and to increase conversions.

Headers need to give the entire page a flow, an order. Headers provide a structured progression of information bits in specific order to maximize engagement, trust and establishment of authority. This structured sequence of information guides traffic through the process, from not trusting the site and having no idea if the site is legitimate, to considering the page, and ultimately considering the site as thrust worthy and a viable option to provide the service the client desires. This promotes site credibility and conversion. To maximize this the heading wording should be chosen to make an impact on traffic, for example, by being engaging and prompting users to read more.

When it comes to SEO, headers also play a significant role and SEO should always be kept in mind when choosing header wording. The keywords determined above should be used inside the headers. Search engines typically use the headers to determine the subject matter of the page, and the more search engines know about the page the better the search engine can match the page to keywords entered that are relevant to the site, thus ranking higher for relevant keywords.

Title tags are significant in that search engines determine the subject matter of a page similar to the way a title of a book describes what the book as a whole is about. The content of the may be subcategorized in chapters that each describe the subdivision. An H1 Title Tag is much like the title of a book and gives a description of what the page in its entirety is about. The pages main title and most sought after keyword should be included in the H1 tag. The H2 Title Tag generally informs the search engine as to the content of the paragraph following the H2 title tag. The On Page SEO: Conversion and Credibility Strategies includes a step by step guide for creating title tags.

Once the content is written, the content may be modified to include Latent Semantic Indexing (LSI) Keywords. Caution should be exercised to avoid over optimizing keywords. The content should be written as if in an organic conversation with someone and should include different variations of the keywords. For example, variations for the word “House” may include “Home” and “Property.” Variations for the word “Buy” may include “Purchase” and “Acquire.”

Once the LSI keywords have been emphasized, it would be advantageous to add visuals, pictures, info-graphics, videos, and other media. Caution should be exercised when adding media, and media may be added so long as it makes sense, makes it easier to understand and to provide more impact on the user, as opposed to adding media for its own sake. A significant task when adding media is to optimize the size of the media to ensure an attractive appearance and a desirable loading speed. Step by step guidance for optimizing media size may be provided and may utilize commercially available applications.

An additional task includes linking out to external authoritative web sites and to also link out to pages that feature the present web site. Linking to high Domain Authority and Page Authority websites on which colleagues are featured and linking to their links is a recommended strategy. It should be noted that anchor text (clickable text that sends the user to the backlinked page) for linking out may have a significant effect, and using anchor text that includes the present web site's keywords as opposed to the backlinked page's keywords is advantageous.

An On Page Optimization Checklist may be provided to ensure compliance with the techniques described above.

The On-Page SEO “Sell My House” task 1420 includes applying the On Page SEO: Conversion and Credibility Strategies 830 to specific web site pages, for example, to a “Sell My House Page” on a real estate business's web site.

### Off Page Seo: Getting Established as an Authority 835

As shown in FIG. 15, the Off page SEO: Getting Established as an Authority 835 activity may include the following tasks: Create Profiles For Your 3rd Party Blog Webpage Websites 1505, Write An Article On One Of Your 3rd Party Blog Accounts 1510, Write 2 Blog Posts On Your Private Blogs (Weekly Task) 15515, Have at least 2 relevant journalism source Account Pitches submitted 1520, Relevant Forums Posting 1525, and an Optional Approach 1530.

The Create Profiles For Your 3rd Party Blog Webpage Websites task 1505 includes using high domain authority and page authority websites to find websites on which a profile may be created, creating a profile and starting to blog. Having at least 3 full blog entries on each of these profiles will provide enough interlinking between the blogs on these sites to make a difference in authority.

Write An Article On One Of Your 3rd Party Blog Accounts 1510 requires having previously set up one or more profiles on 3rd party web sites that pertain to a particular industry or business type. The task includes writing a blog entry in order to generate credibility, to be recognized as an authority, and to generate leads and backlinks.

The Write 2 Blog Posts On Your Private Blogs (Weekly Task) 1515 requires having previously set up 2 blog websites. The task includes writing a blog entry for each of the blogs and requires some effort in order to attract visitors, bring value and entertainment to the visitors, have the visitors like the content, and cause search engines to rank at #1 as quickly as possible.

The “Have at least 2 Relevant Journalism Source Account Pitches Submitted” task 1520 includes submitting and having at least 2 articles accepted by a Journalism Source Service, for example, Help A Reporter Out (HARO) or other article sourcing service.

The Relevant Forums Posting task 1525 includes participating in discussions and answering questions on forums relevant to the subjects to which the web site is directed in order to generate credibility, to be recognized as an authority.

The Optional Approach 1530 includes searching online for the same topic of one of the blogs, browsing the results and listing the sites that are relevant to that topic and have a good domain authority, and sending them an email requesting they add your link to the blog article you wrote onto their blog.

### Off Page Seo: Backlink Building 840

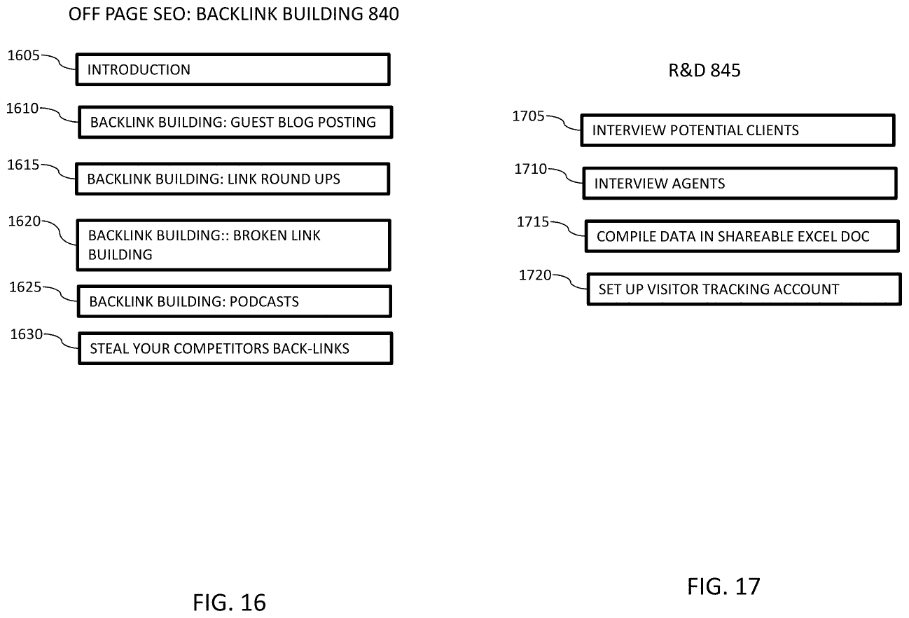

As shown in FIG. 16, the Off page SEO: Backlink Building activity 840 may include the following tasks: Introduction 1605, Backlink Building: Guest Blog Posting 1610, Backlink Building: Link Round Ups 1615, Backlink Building: Broken Link Building 1620, Backlink Building: Podcasts 1625, and Steal Your Competitors Back-Links 1630.

The Introduction 1605 generally points out the importance of building backlinks.

The Backlink Building: Guest Blog Posting task 1605 involves obtaining a backlink to the present site featured on a niche related authoritative site. Ideally the backlink is a “do follow” backlink which often will be the case. This process may be divided into 2 steps: first, finding websites within the same niche that allows guest posting. This is a matter of trial and error. Second, writing a blog post that complements and brings value to the external site you are pitching to. A step by step guide for finding authoritative sites includes using a link analysis tool, for example, MOZ.com to display the domain and page authority of sites, and browsing related sites to find those with high domain and page authority. Once a set of possible sites is located a pitch may be made to the web sites offering to write a value added blog post.

The Backlink Building: Link Round Ups task 1610 includes finding a set of authoritative sites from which a link would be beneficial using monthly summaries of top links that sites share. There are websites that accumulate or “round up” significant blog posts and post a list of these on their site, so that viewers may get value from the listed blogs. Link roundup sites may be found by searching on Twitter using a specific set of keywords, for example:

a. “Keyword+link roundup”

b. “Keyword”+“Link Roundup”

c. “Keyword”+Roundup

d. “Keyword”+“Best of”

e. “Keyword”+This week”

The sites may be evaluated as to their Domain Authority and Page Authority, their webmaster's contact information found, and an offer to write may be sent to the webmaster.

The Backlink Building: Broken Link Building task 1615 may include searching for a site from which to obtain a link, such as a site with desirable Domain Authority and Page Authority ratings, discovering any broken links to the target site, and offering a link to the present web site as a replacement.

The Backlink Building: Podcasts task 1620 may be accomplished by searching for podcasts with similar content and simply asking the administrator if they need additional participants.

The Steal Your Competitors Back-links task 1625 involves using a backlink checker to copy a competitors backlink efforts.

### R&D 845

As shown in FIG. 17, the R&D activity 845 may include the following tasks: Interview Potential Clients 1705, Interview Agents 1710, Compile Data In Shareable Excel Doc 1715, Set Up Crazy Egg Account 1720

The Interview Potential Clients task 1705 generally includes posing questions to potential clients eliciting comments about the website, for example, What did you like on the site?, What Could Be improved?, What was not clear?, What was missing?, and What could I add for you to choose us?

The Interview Agents task 1710 includes asking agents that represent clients questions related to client needs, for example, what clients are looking for, difficulties clients have finding agents, why clients use or do not use agents, and why agents lose clients.

The Compile Data In Shareable Excel Doc task 1715 includes compiling data from clients that use the disclosed search engine optimization platform regarding site improvements, for example, techniques for attracting traffic, conversion techniques, SEO techniques, etc. The data from a number of clients may be compiled into a sharable format so that all the participating users as a group may benefit from the experiences of the other clients.

The Set Up a Visitor Tracking Account task 1720 includes adding tracking code to the web site using for example, CRAZY EGG, to track visitors behavior. Behavior that may be tracked may include which web site portions attract attention, which links are most selected, etc.

### Advanced SEO Strategies 850

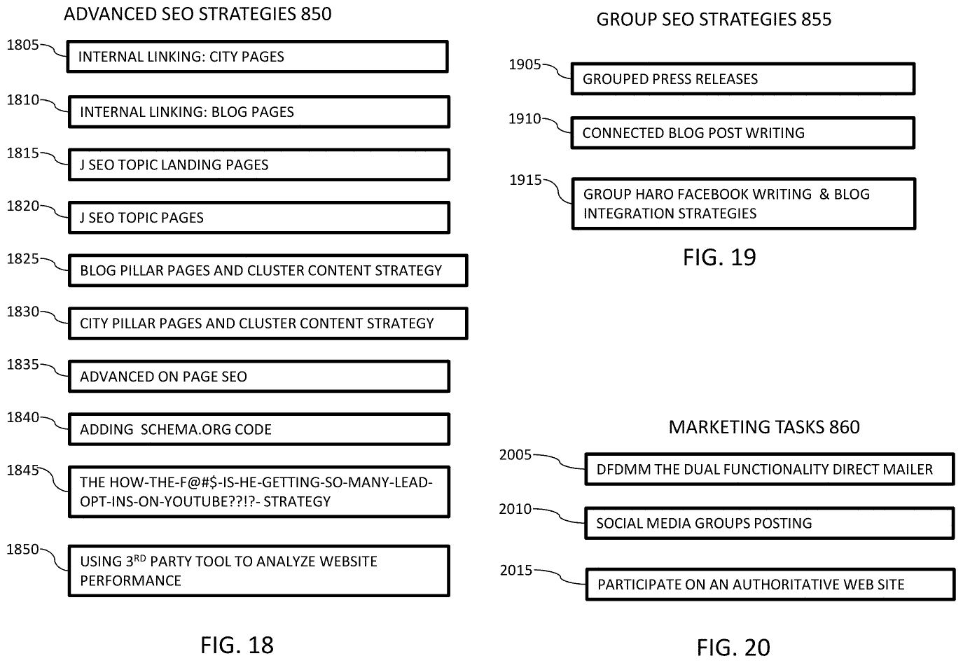

As shown in FIG. 18, the Advanced SEO Strategies activity 850 may include the following tasks: Internal Linking: City Pages 1805, Internal Linking: Blog Pages 1810, J SEO Topic Landing Pages 1815, J SEO Topic Pages 1820, Blog Pillar Pages And Cluster Content Strategy 1825, City Pillar Pages And Cluster Content Strategy 1830, Advanced On Page SEO 1835, adding Schema.org code 1840, The How-The-F@#$-Is-He-Getting-So-Many-Lead-Opt-Ins-On-YouTube??!?—Strategy 1845, GTMetrix 1850.

The Internal Linking: City Pages task 1805 and Internal Linking: Blog Pages task 1810 generally include interlinking the blog posts by pillar pages and topic content. Having several similar topics linked together will cause search engines to relate the cluster of pages and therefor rank the pages that are part of the cluster higher in search engine results. The tasks further include strategically choosing pillar pages to feed specific city pages to rank high. In this manner, the city pages will become stronger which is not only good for ranking that specific single page higher but as a result of doing so for many city pages, many pages on the present domain name will rank high as opposed to only the home page, as everyone only directs backlinks to only the home page. Having many pages gain strength conveys to the various search engines that the website as a whole provides value to the user and will cause the website to climb faster, and will anchor the website position more robustly.

In order to strategically link the blogs by arranging and grouping them by topics, a method for identifying each blog needs to be developed, for example, by numbering each blog post in order they were published. The blogs may then be modified to rank for local searches. The blogs are automatically populated and published based on the preset fields set by the user profile so changing the preset settings to specific cities will cause the blogs to rank for those cities. In order to keep track of the interlinks they may be compiled into a spreadsheet.

The J SEO Topic Landing Pages task 1815 includes setting up a number of web pages that address specifics topic related to the web site subject matter and posting very specific advertisements on social media that link to those specific topics.

The J SEO Topic Pages 1820 includes setting up a number of web pages that address the specifics topic related to the web page subject matter that are not linked to any advertisements but may be found by users searching for those specific topics.

The Blog Pillar Pages And Cluster Content Strategy task 1825 involves providing a web page that generally describes a topic, designating that page as a pillar page, providing additional web pages that cover specific aspects of the topic, linking the pillar page to the additional web pages, and linking the additional web pages to the pillar page. The pillar page thus serves as a hub and the additional pages serve as spokes of the cluster.

The City Pillar Pages And Cluster Content Strategy task 1830 uses the same strategy for web pages within the web site that may be directed to a specific city.

The Advanced On Page SEO task 1835 includes reapplying the On Page SEO: conversion and Credibility Strategies discussed above to the web pages again after the modifications have been incorporated.

The adding Schema.org code task 1840 includes using code developed by the Schema.org community to more clearly provide information to search engines in order to understand web page content, resulting in providing users with snippets or graphics displayed in the search results.

The How-The-F@#$-Is-He-Getting-So-Many-Lead-Opt-Ins-On-YouTube??!?-Strategy 1845 that applies the J SEO Topic Pages strategy described above to social media sharing sites, for example, Facebook. The task includes creating YouTube channels featuring videos, each channel related to the specific topic of one of the web site topic pages, and providing a link from the channel to the related web site topic page. For example, a link to the topic page may be attached to the banner art for the associated YouTube channel.

The Using 3^{rd} Party Tools To Analyze Website Performance task 1850 includes using a third party application, for example, GTMetrix to analyze the performance of the website. Performance metrics may include picture optimization, loading speed, and various other metrics that may be improved if found deficient. The third party tool may also provide suggestions for improving performance.

### Group SEO Strategies 855

As shown in FIG. 19, the Group SEO Strategies activity 855 may include the following tasks: Press Release 1905, Connected Blog Post Writing 1910, and Group HARO Facebook Sharing & Blog Integration Strategies 1915. Generally this activity takes advantage of the efforts of a group of clients using the disclosed search engine optimization strategies. The group may perform tasks together using their respective web sites that bring about mutual synergistic improvements in search engine results.

The Grouped Press Releases task 1905 generally includes releasing press releases on related topics at the same time with links between them. However, the links are fashioned in a chain or loop, such that each press release has a single link to the next release and the last release links to the first release. This results in a higher quality link for each release than having each release link to every other release, providing a higher search engine ranking.

The Connected Blog Post Writing task 1910 and Group HARO Facebook Sharing & Blog Integration Strategies 1915 involve coordinating blog posts among clients using the disclosed search engine optimization strategies by writing blog posts with complimentary subjects and providing links between the blog posts. For example, a first client may coordinate with a second client where the first client may write blog about how to make fishing lures, the second client may write a blog about tying knots, and the blogs may include links to each other.

### Marketing Tasks 860

As shown in FIG. 20, the Marketing Tasks activity 860 may include the following tasks: DFDMM The Dual Functionality Direct Mailer 2005, Facebook Groups Posting 2010, Write An Article On an Authoritative Web Site 2015.

The DFDMM The Dual Functionality Direct Mailer task 2005 includes composing a direct mailer that generally adds something of value that will cause the card to end up being hung on a refrigerator, bulletin board, or other household notification area. For example, the direct mailer may include a recipe, grocery list template, mini fridge magnet whiteboard, etc.

The Social Media Groups Posting task 2010 includes generating and responding to social media, for example, Facebook, posts in a thoughtful, contributing way to maximize engagement, trust and ultimately to generate leads.

The Participating On An Authoritative Web Site task 2015 includes writing one or more articles and participating in forums on a web site recognized as an authoritative source for information about a particular industry or activity. For example, a real estate investor may participate on BiggerPockets.com to establish themselves as an authority, increase trust and credibility, and obtain backlinks.

As mentioned above, the disclosed system and method for improved process management may be used for accomplishing various processes, for example for implementing a real estate wholesaling process.

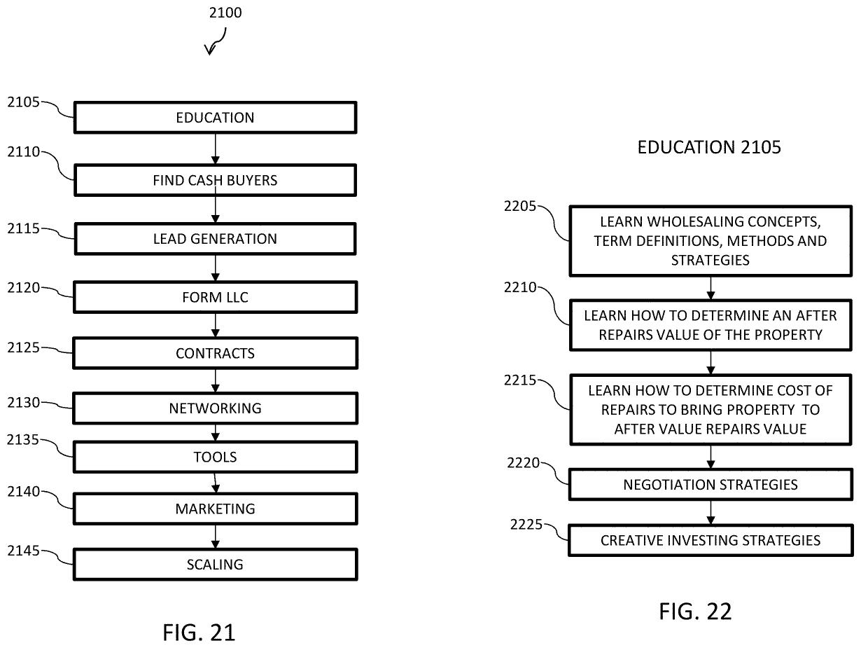

FIG. 21 shows a block diagram 2100 of groups of activities for implementing a real estate wholesaling process according to the disclosed embodiments. Real estate wholesaling is a process that includes finding off market properties where the owners are willing to sell at deeply discounted prices. A wholesaler then puts the property under contract at a specific amount, and then sells the contract for a higher amount than the amount under contract. The difference represents revenue for the wholesaler.

As shown in FIG. 21, a set of activities for implementing the real estate wholesaling process may include education 2105, finding cash buyers 2110, lead generation 2120, forming an LLC 2125, learning about and entering into contracts 2130, networking 2135, using real estate wholesaling process tools 2140, marketing 2145, and scaling 2150.

### Education 2105

Referring to FIG. 22, the education activity 2105 may include the following tasks: learn property wholesaling concepts, term definitions, property wholesaling methods and strategies 2205, learn how to determine an after repairs value of the property 2210, learn how to determine the cost of repairs to bring property to the after repairs value 2215, Learn negotiation strategies 2220, and learn creative investing strategies 2225.

### Find Cash Buyers 2110

Referring again to FIG. 21, the finding cash buyers activity 2110 may include learning methods to find cash buyers and house flippers, using for example, social media such as Craigslist, REI Meet-Ups etc.

### Lead Generation 2115

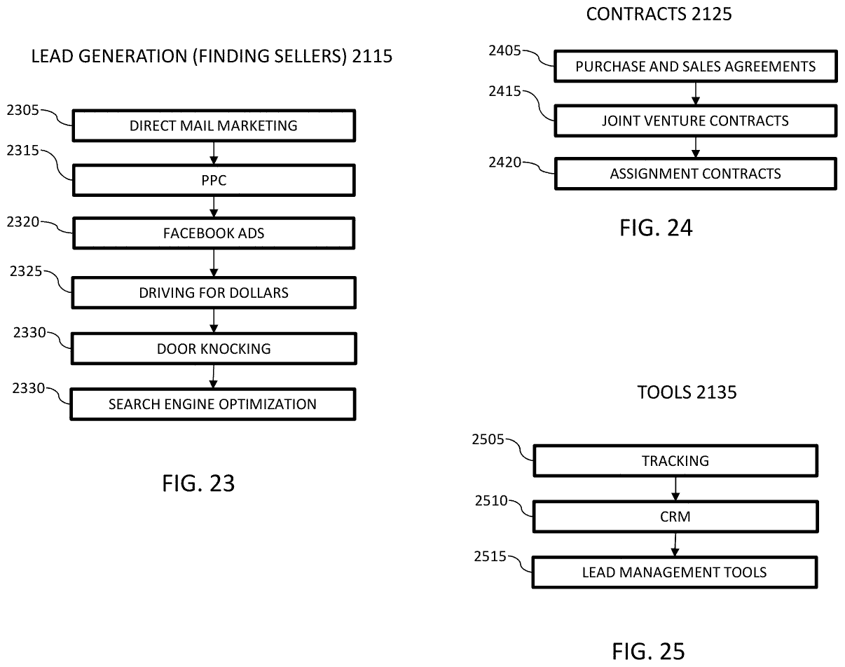

Turning to FIG. 23, the lead generation (finding sellers) activity 2115 includes direct mail marketing 2305, PPC 2310, Facebook advertisements 2320, driving for dollars 2325, door knocking 2330, and search engine optimization 2330.

### Forming an LLC 2120

Returning to FIG. 21, the forming an LLC activity 2120 includes forming a limited liability company corporate entity for the real estate wholesaling enterprise.

### Contracts 2125

Referring to FIG. 24, the contracts activity 2125 may include learning about and obtaining purchase and sales agreement 2405, joint venture contracts 2415, and assignment contracts 2420.

### Networking 2130

Returning to FIG. 21, the Networking activity 2130 includes networking with various real estate industry professionals, for example, agents, attorneys, cash buyers, etc.

### Tools 2135

Turning to FIG. 25, the tools activity 2135 may include learning and implementing various tools useful for real estate wholesaling such as tracking tools 2505, CRM tools 2510, and lead management tools 2515.

### Marketing 2140 and Scaling 2145

Returning to FIG. 21, the marketing and scaling activities 2140, 2145 may include various advertising tasks various tasks related to expanding the real estate wholesaling business.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Various features of the different embodiments described herein are interchangeable, one with the other. The various described features, as well as any known equivalents can be mixed and matched to construct additional embodiments and techniques in accordance with the principles of this disclosure.

Furthermore, some of the features of the exemplary embodiments could be used to advantage without the corresponding use of other features. As such, the foregoing description should be considered as merely illustrative of the principles of the disclosed embodiments and not in limitation thereof.

What is claimed is:

1. A method for improved process management of search engine optimization of a web site including a set of processes comprising:
using an external device interface of a user terminal to display a set of initial web site preparation tasks for completion by a user, using an administrator console to monitor the user's progress in completing the initial web site preparation tasks, and to determine completion of the initial web site preparation tasks;
using the external device interface to display a set of branding and social media promotion tasks for completion by the user, using the administrator console to monitor the user's progress in completing the branding and social media promotion tasks, and to determine completion of the branding and social media promotion tasks;
using the external device interface to display a set of web site set up tasks for completion by the user, using the administrator console to monitor the user's progress in completing the web site set up tasks, and to determine completion of the web site set up tasks;
using the external device interface to display a set of content strategies for completion by the user, using the administrator console to monitor the user's progress in completing the content strategies, and to determine completion of the content strategies;
using the external device interface to display a set of on page search engine optimization strategies for completion by the user, using the administrator console to monitor the user's progress in completing the on page search engine optimization strategies, and to determine completion of the on page search engine optimization strategies;
using the external device interface to display a set of conversion and credibility strategies for completion by the user, using the administrator console to monitor the user's progress in completing the conversion and credibility strategies, and to determine completion of the conversion and credibility strategies;
using the external device interface to display a set of tasks for establishing the web site as an authoritative source of information for completion by the user, using the administrator console to monitor the user's progress in completing the set of tasks for establishing the web site as an authoritative source of information, and to determine completion of the set of tasks for establishing the web site as an authoritative source of information;
using the external device interface to display a set of tasks for backlink building for completion by the user, using the administrator console to monitor the user's progress in completing the set of tasks for backlink building, and to determine completion of the set of tasks for backlink building;
using the external device interface to display a set of tasks for research and development for completion by the user, using the administrator console to monitor the user's progress in completing the set of tasks for research and development, and to determine completion of the set of tasks for research and development;
using the external device interface to display a set of tasks for implementing advanced search engine optimization strategies for completion by the user, using the administrator console to monitor the user's progress in completing the set of tasks for implementing advanced search engine optimization strategies, and to determine completion of the set of tasks for implementing advanced search engine optimization strategies;
using the external device interface to display a set of tasks for implementing group search engine optimization strategies for completion by the user, using the administrator console to monitor the user's progress in completing the set of tasks for implementing group search engine optimization strategies, and to determine completion of the set of tasks for implementing group search engine optimization strategies; and
using the external device interface to display a set of marketing tasks for completion by the user, using the administrator console to monitor the user's progress in completing the set of marketing tasks, and to determine completion of the set of marketing tasks.

2. The method of claim 1, comprising using the administrator console to evaluate the tasks as they are determined to be completed and provide feedback as to whether the tasks have been completed successfully

3. The method of claim 2, comprising displaying certain tasks on the user terminal only after other tasks have been determined to be completed successfully.

4. The method of claim 1, wherein the set of initial web site preparation tasks includes selecting and registering a domain name, verifying ownership of the domain name with a search engine, subscribing to a service that provides analytics of a website having the domain name, acquiring a business registration, phone number and email, setting up an account with a content service providing specialized content to journalists, and generating a standalone blog site.

5. The method of claim 1, wherein the set of branding and social media promotion tasks includes designing a website logo, and creating a video streaming, photo and video sharing, business networking, and social media account.

6. The method of claim 1, wherein the set of web site set up tasks includes removing a sidebar from the website, providing a clickable phone number on the website, adding contact information in a footer of the website, adding buttons that invoke social media to the website, and using an automated blog post service to provide content to a particular blog site.

7. The method of claim 1, wherein the set of content strategies includes using a structured content writing procedure to generate content for the website.

8. The method of claim 1, wherein the set of conversion and credibility strategies includes converting block titles on the website to headers to provide a header structure for article publications, determine key words for use in the web site, include one or more keywords in a title tag of the website, including Latent Semantic Indexing (LSI) Keywords in content of the website, and adding additional media to the website.

9. The method of claim 1, wherein the set of tasks for establishing the web site as an authoritative source of information includes locating websites on which a profile may be created, creating a profile on those websites and generating one or more blogs on those websites, obtaining acceptance of articles on a content service providing specialized content to journalists, and participating in discussions and answering questions on forums relevant to the subjects to which the web site is directed.

10. The method of claim 1, wherein the set of tasks for backlink building includes obtaining backlinks to the website from one or more niche related authoritative sites.

11. The method of claim 1, wherein the set of tasks for research and development includes posing questions to potential clients eliciting comments about the web site, posing questions to agents representing the potential clients related to client needs regarding the website, compiling answers from the clients and agents for sharing among users, and adding tracking code to the website for tracking visitor behavior.

12. The method of claim 1, wherein the set of tasks for implementing advanced search engine optimization strategies includes interlinking blog posts by pillar pages and topic content, implementing web pages that address specific topics related to subject matter of the website and are linked to social media advertisements, and implementing web pages that address specific topics related to subject matter of the website and are not linked to social media advertisements.

13. The method of claim 1, wherein the set of tasks for implementing group search engine optimization strategies includes releasing press releases, and writing blog posts with complementary subjects.

14. The method of claim 1, wherein the set of marketing tasks includes composing and mailing a direct mailer, posting on social media, and participating on an authoritative web site.

15. A system for improved process management of processes for search engine optimization of a web site, the system comprising:
an external device interface of a user terminal configured to display a set of initial web site preparation tasks for completion by a user, an administrator console configured to monitor the user's progress in completing the initial web site preparation tasks, and for allowing an administrator to determine completion of the initial web site preparation tasks;
the external device interface further configured to display a set of branding and social media promotion tasks for completion by the user, wherein the administrator console is further configured to monitor the user's progress in completing the branding and social media promotion tasks, and for allowing the administrator to determine completion of the branding and social media promotion tasks;
the external device interface further configured to display a set of web site set up tasks for completion by the user, wherein the administrator console is further configured to monitor the user's progress in completing the web site set up tasks, and for allowing the administrator to determine completion of the web site set up tasks;
the external device interface further configured to display a set of content strategies for completion by the user, wherein the administrator console is further configured to monitor the user's progress in completing the content strategies, and for allowing the administrator to determine completion of the content strategies;
the external device interface further configured to display a set of on page search engine optimization strategies for completion by the user, wherein the administrator console is further configured to monitor the user's progress in completing the on page search engine optimization strategies, and for allowing the administrator to determine completion of the on page search engine optimization strategies;
the external device interface further configured to display a set of conversion and credibility strategies for completion by the user, wherein the administrator console is further configured to monitor the user's progress in completing the conversion and credibility strategies, and for allowing the administrator to determine completion of the conversion and credibility strategies;
the external device interface further configured to display a set of tasks for establishing the web site as an authoritative source of information for completion by the user, wherein the administrator console is further configured to monitor the user's progress in completing the set of tasks for establishing the web site as an authoritative source of information, and for allowing the administrator to determine completion of the set of tasks for establishing the web site as an authoritative source of information;
the external device interface further configured to display a set of tasks for backlink building for completion by the user, wherein the administrator console is further configured to monitor the user's progress in completing the set of tasks for backlink building, and for allowing the administrator to determine completion of the set of tasks for backlink building;
the external device interface further configured to display a set of tasks for research and development for completion by the user, wherein the administrator console is further configured to monitor the user's progress in completing the set of tasks for research and development, and for allowing the administrator to determine completion of the set of tasks for research and development;
the external device interface further configured to display a set of tasks for implementing advanced search engine optimization strategies for completion by the user, wherein the administrator console is further configured to monitor the user's progress in completing the set of tasks for implementing advanced search engine optimization strategies, and for allowing the administrator to determine completion of the set of tasks for implementing advanced search engine optimization strategies;
the external device interface further configured to display a set of tasks for implementing group search engine optimization strategies for completion by the user, wherein the administrator console is further configured to monitor the user's progress in completing the set of tasks for implementing group search engine optimization strategies, and for allowing the administrator to determine of the set of tasks for implementing group search engine optimization strategies; and
the external device interface further configured to display a set of marketing tasks for completion by the user, wherein the administrator console is further configured to monitor the user's progress in completing the set of marketing tasks, and for allowing the administrator to determine completion of the set of marketing tasks.

16. The system of claim 15, wherein the administrator console is further configured to allow the administrator to evaluate the tasks as they are determined to be completed and provide feedback as to whether the tasks have been completed successfully

17. The system of claim 17, wherein the administrator console is further configured to enable displaying certain tasks on the user terminal only after other tasks have been determined to be completed successfully.
